(19) United States
(12) Patent Application Publication
(10) Pub. No.: US 2013/0206078 A1
(43) Pub. Date: Aug. 15, 2013

(54) SYSTEM AND METHOD FOR CONTROLLING FEEDING OF FARMED FISH

(71) Applicants: Rune Melberg, Stavanger (NO); Thomas Torgersen, Bergen (NO)

(72) Inventors: Rune Melberg, Stavanger (NO); Thomas Torgersen, Bergen (NO)

(73) Assignees: HAVFORSKININGSINSTITUTTET, Bergen (NO); UNIVERSITETET I STAVANGER, Stavanger (NO)

(21) Appl. No.: 13/698,627

(22) PCT Filed: May 5, 2011
(86) PCT No.: PCT/NO2011/000144

§ 371 Date: Jan. 30, 2013

(30) Foreign Application Priority Data
May 18, 2010 (NO) 20100718

(51) Int. Cl. A01K 61/02

(52) U.S. Cl. CPC A01K 61/02
USPC 119/230

(57) ABSTRACT

The invention relates to a system for controlling feeding of farmed fish living within a restricted volume, such as a sea cage (10), comprising at least one sensor for direct or indirect measurement of changes in dissolved oxygen (DO) in a feeding area of the fish during feeding, and further comprising a controller (4) receiving input from said at least one sensor and providing output to an automated feed providing system for controlling the amount of food provided to the fish, wherein an increased oxygen consumption and a correspondingly decreased amount of DO in said feeding area serves as an indication of fish hunger and an input parameter of the controlling system. The invention also relates to a method for controlling feeding of farmed fish.

The present invention relates to a system and a method for controlling feeding of farmed fish, and more specifically a system and a method as stated in the introducing part of claims 1 and 8, respectively.

Fish farming has become an important export industry in several countries, and a valuable source of feed around the world. Norway is the largest exporter of farmed Atlantic salmon, exporting 362 000 metric tons of salmon with a total value of 10.7 billion NOK in the first half of 2009.

The distribution of feed in Norwegian fish farms is mostly done by semi-automated feed distribution systems. It is also common to use growth matrixes to calculate predicted feed usage based on fish size and water temperature. Several sensor systems have been proposed to automate the feeding control, but still these systems require skilled personnel monitoring fish surface behaviour or images from underwater camera during feeding, so that these personnel actually controls the feeding as in the case of the majority of Norwegian fish farms today.

Oxygen measurements are presently used in fish farming to prevent feeding during poor oxygen conditions or during conditions where feeding may result in poor oxygen conditions. One then operates with limit values for acceptable oxygen saturations in the water, and these values vary for different species and are also temperature dependent.

An object of the present invention is thus to provide a system and a method that is more accurate and less depending on skilled personnel or experts during feeding, as incorrectly feeding may lead to many problems such as feed wastage and other negative environmental effects, reduced growth, reduced profitability and less sustainable production, etc.

The invention aims at solving or at least mitigating the above or other problems or deficiencies, by means of a system and a method as stated in the characterizing clause of claims 1 and 8, respectively.

Advantageous embodiments of the invention are stated in the dependent claims.

A central feature of the invention is thus use of measurements of the oxygen concentration in sea cages in order to identify the hunger of the fish (salmons). During feeding hungry fish will gather in the feeding area and the fish will also chase the feed as long as it is hungry. Both these effects result in an increased consumption of oxygen in the feeding area/the area were the fish is gathering to eat. Much of the feeding today is controlled by assessment of the hunger of the fish based on observations at sea level or based on video pictures from the cages, and in this case it is the gathering of fish and the eager of the fish to chase feed which are being assessed.

In the enclosed drawings,

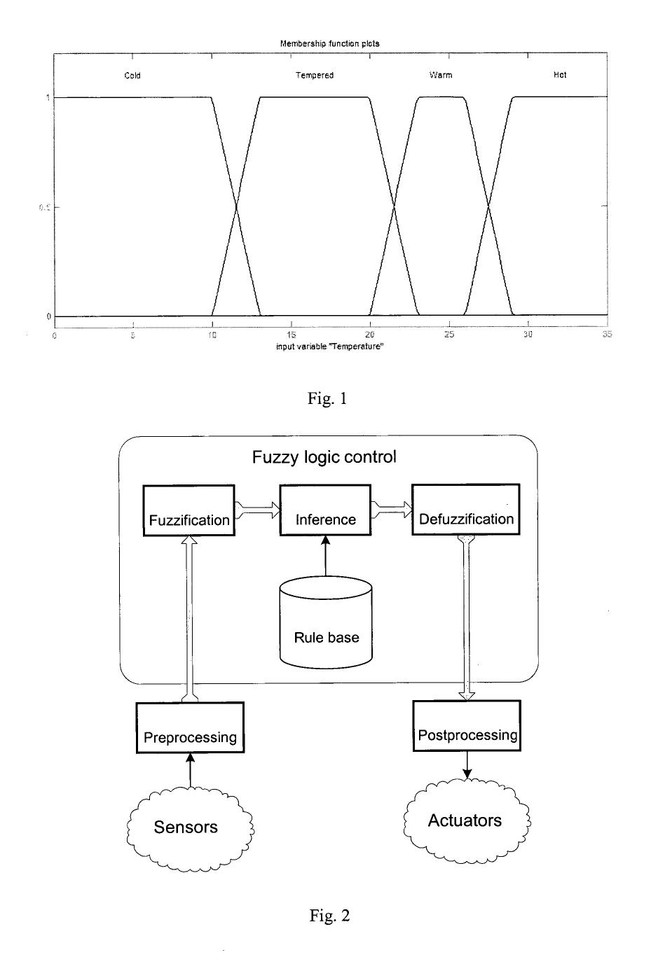

FIG. 1 is diagram showing an exampled membership function,

FIG. 2 is a principle drawing of a Fuzzy logic controller,

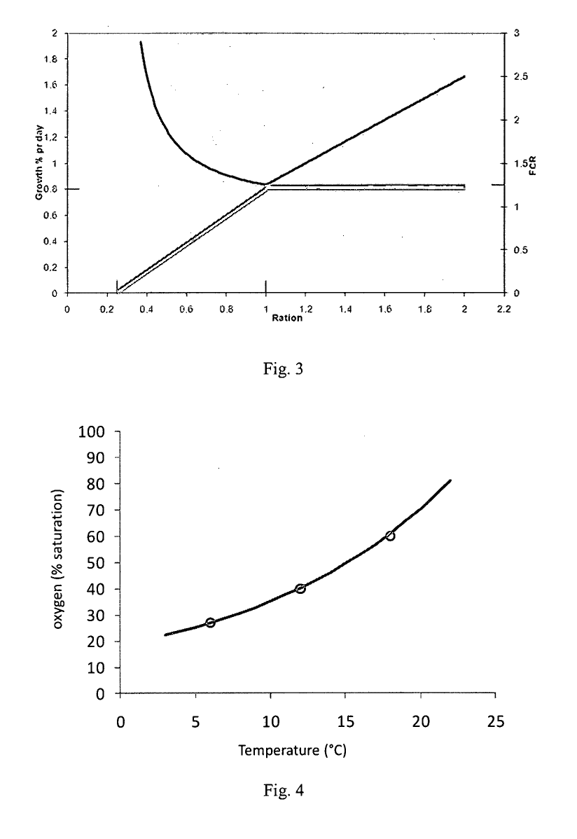

FIG. 3 shows a theoretical relationship between amount of offered feed and growth rate and feed conversion ratio,

FIG. 4 is a diagram showing critical oxygen saturation for post-smolt salmon at different temperatures (under the line, the fish are unable to sustain normal metabolism),

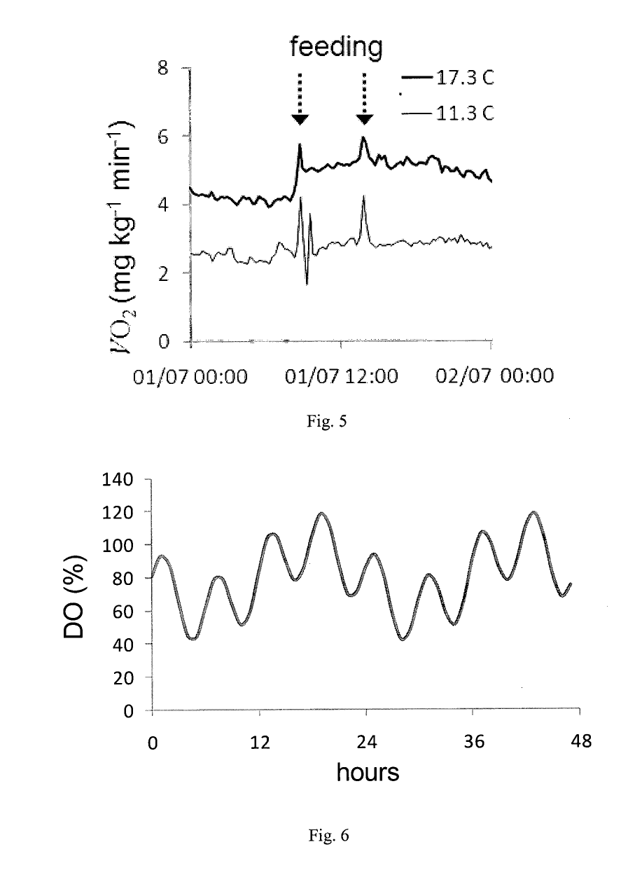

FIG. 5 is a diagram showing that the oxygen concentration rate increases with temperature and also during feeding and digestion (after feeding),

FIG. 6 is an idealized illustration showing that tide and photosynthesis cycles cause fluctuating oxygen levels in sea cages,

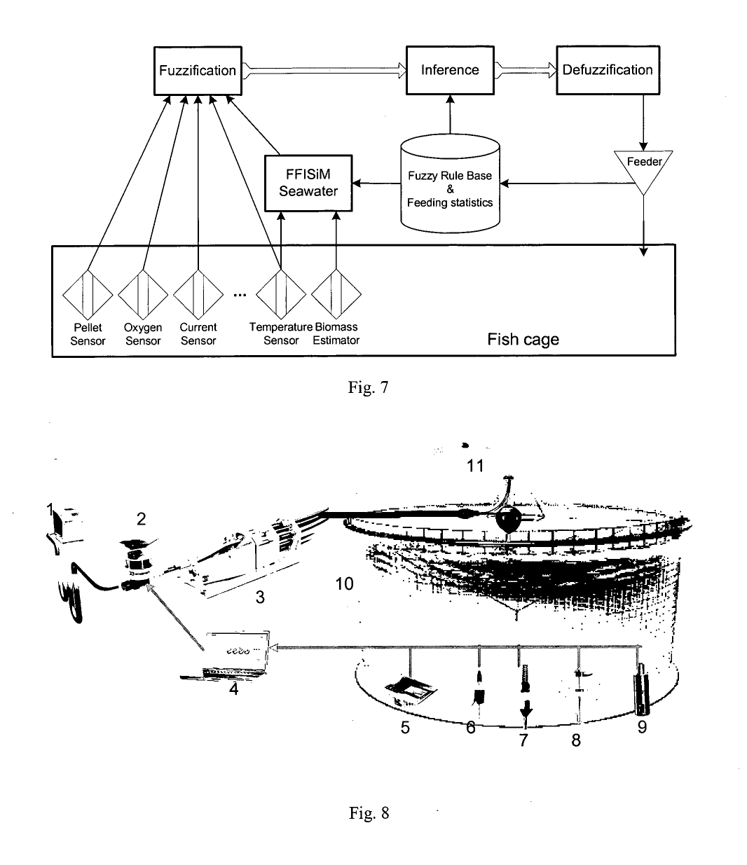

FIG. 7 is a principle layout of Fuzzy logic controlled automated feeding system, utilizing an “FFISiM Seawater” simulation model,

FIG. 8 is an example embodiment of a layout of a system according to the present invention,

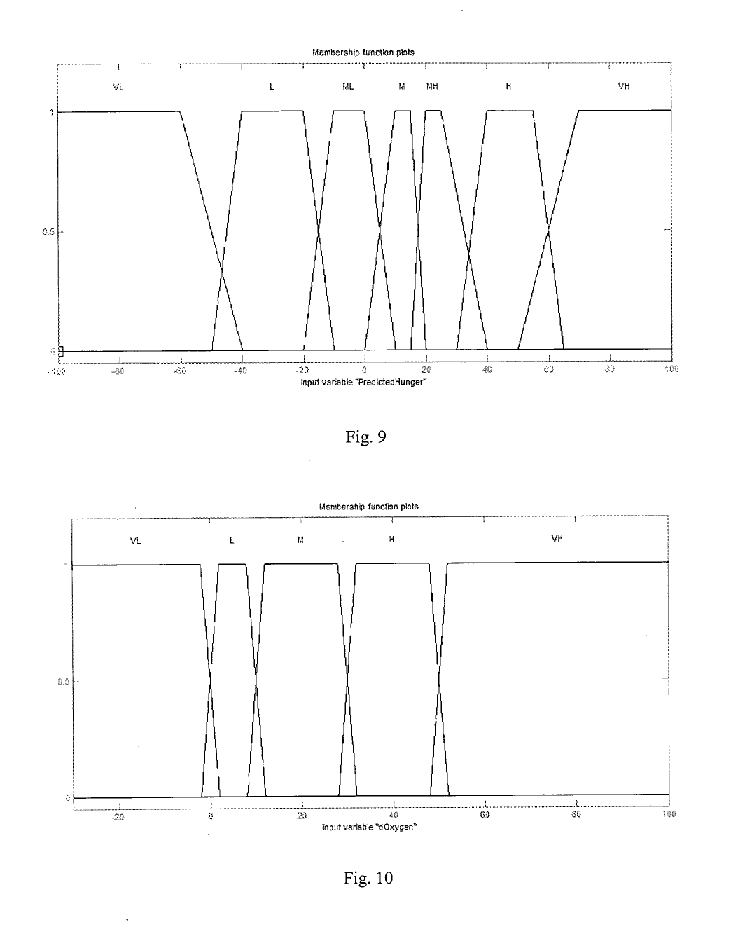

FIG. 9 is a diagram showing hunger membership functions,

FIG. 10 is a diagram showing dDO (changes in Dissolved Oxygen) membership functions,

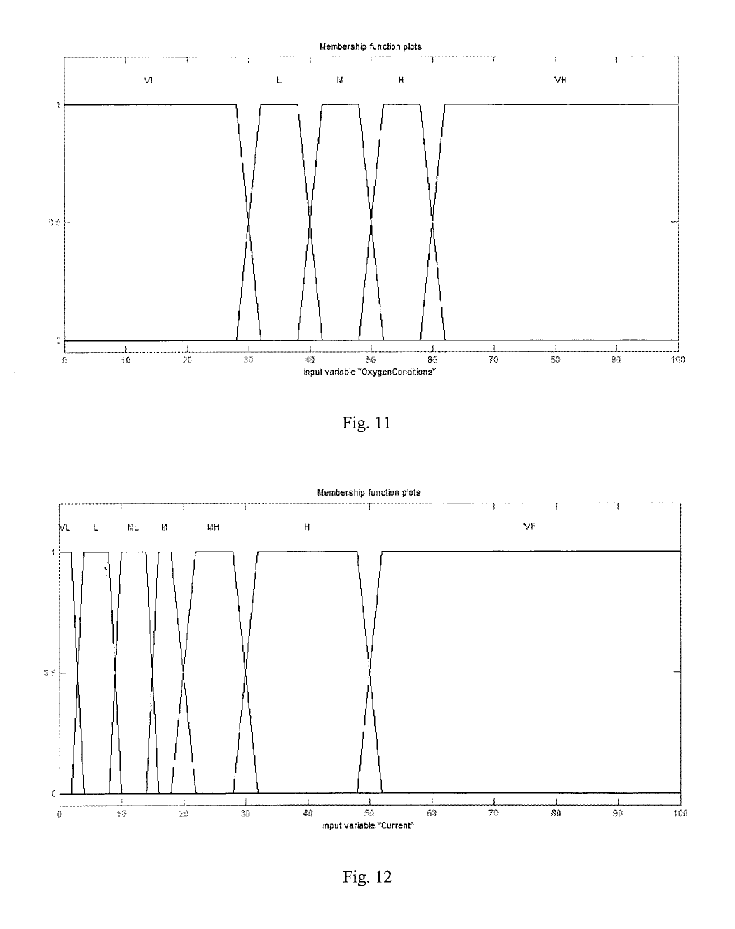

FIG. 11 is a diagram showing an oxygen condition membership function,

FIG. 12 is a diagram showing a current membership function,

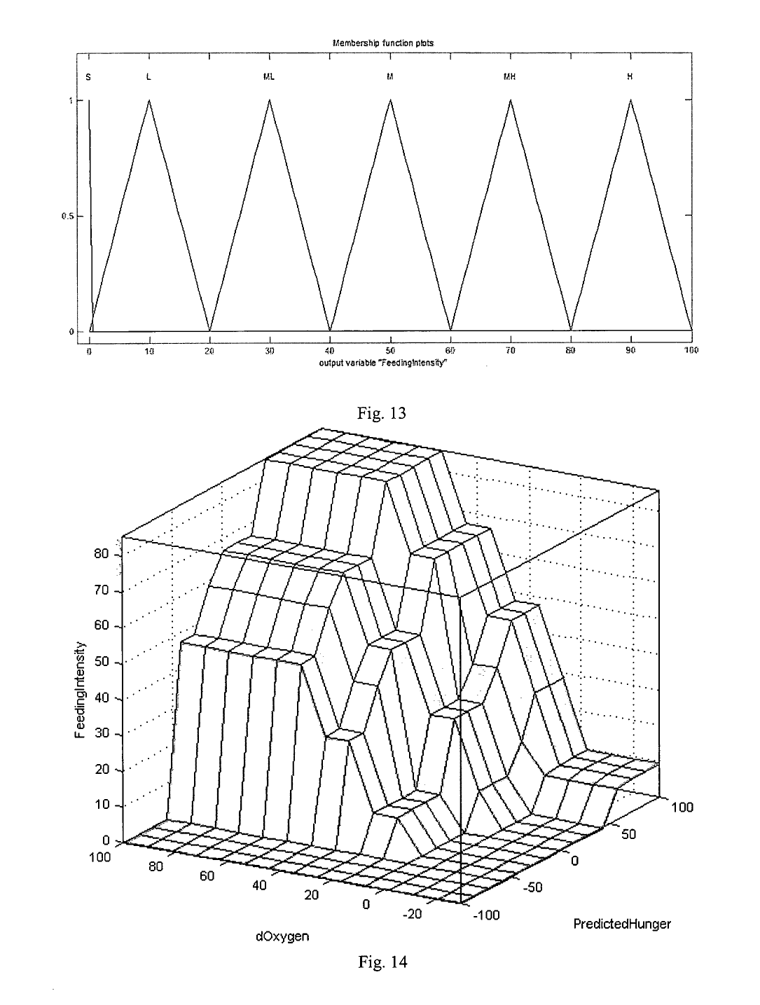

FIG. 13 is a diagram showing a feeding intensity membership function, and

FIG. 14 is a diagram showing a control surface for feeding intensity for different combinations of oxygen consumption and predicted hunger, and wherein the figure displays 3 of 5 dimensions of the total control surface.

This disclosure proposes a Fuzzy logic based approach for automation of the feeding process based on available sensor inputs, expert knowledge, and simulation model of the fish farming process.

Computer systems are built on the concept of true and false (1 and 0) and in classical crisp sets the elements either have full membership or no membership at all. Fuzzy sets extend this to a continuum of grades of membership, from 0 to 1. Despite of this, a large part of the classes of objects found in the real physical world have no precise definition of the criteria for membership to the class. This could better be supported with different levels of membership in the Fuzzy sets.

So if we could implement controllers to accept noisy, imprecise input, they could be much more effective and possible easier to program. Since the introduction in the mid 70's, Fuzzy control systems have been developed rapidly, lead by researchers and companies from Japan. Fuzzy logic is a promising technology to realize inference engines and it used in diverse industrial applications. Today, fuzzy logic is used in a wide range of applications, from consumer's product such as washing machines, air condition and toasters to more advanced system in robotics and artificial intelligence.

In relation to classical logic, Fuzzy logic, in a narrow sense, can be considered as an extension and generalization of classical multi-valued logic.

Fuzzy logic is a methodology for expressing operational laws of a system in linguistic terms instead of mathematical equations. Systems that are too complex to model accurately using mathematics can be easily modeled using fuzzy logic's linguistic terms. These linguistic terms are most often expressed in the form of logical implications, such as fuzzy if-then rules. For example, a fuzzy if-then rule (or simply a fuzzy rule) looks like:
If temperature is TEMPERED, then
clothing is MEDIUM.
If temperature is WARM, then
clothing is LIGTH.

The terms TEMPERED and MEDIUM are actually sets that define ranges of values as membership functions. By choosing a range of values instead of a single discrete value to define the input parameter “temperature”, we can compute the output value “clothing” more precisely. FIG. 2 shows the membership functions for temperature.

Most rule based systems involves more than just one rule, and aggregation of rules to be able to obtain the overall conclusion from the individual rules could be done by either conjunctive or disjunctive system of rules.

Conjunctive system of rules: y=y¹∩y²∩ . . . ∩yⁿ
Disjunctive system of rules: y=y¹∪y²∪ . . . ∪yⁿ

FIG. 1 shows, just as an example, a membership function for outside temperature in the West Coast part of norway.

The parameters for the Trapezoidal membership functions are listed in Table I below.

TABLE 1

| MEMBERSHI | | | | |
|---|---|---|---|---|
| FUNCTION | A | B | C | D |
| Cold | −35 | −35 | 10 | 10 |
| Tempered | 10 | 13 | 20 | 23 |
| Warm | 20 | 23 | 26 | 29 |

Mathematical reasoning (inference mechanism) in fuzzy logic is based on fuzzy rules that connect input and output parameters (fuzzy rule base), and the membership functions for input and output parameters. To create an inference engine, first the membership functions for input and output parameters must be developed.

FIG. 2 shows the layout for a Fuzzy logic controller. The pre and post processing parts are not considered part of the Fuzzy logic controller, but are of course very important for the overall controlling system. The three phases that makes the fuzzy logic inference mechanism is:

1. Fuzzification. In this phase crisp input values are mapped into fuzzy values.
2. Inference. The fuzzy input parameters are used to compute the fuzzy output values based on rules in the fuzzy rule base.
3. Defuzzification. In this phase the fuzzy output values are converted into crisp values, which could be used for controlling purpose.

The total Aquacultural production cost for Norwegian salmon was 17 Billion NOK in 2007, and the feed cost accounts for approximately 50 percentage of the total production cost. Hence a 2 percentages reduction in feed usage would result in a 170 million NOK reduction of the production cost in 2007.

Correct feeding is very important for achieving good fish farming results. Overfeeding results in waste of costly marine protein and lipid resources when feed passes uneaten through the net cage. Overfeeding also has several negative environmental impacts, such as spread of feed to wild populations of fish and aggregation of waste underneath the fish farm. Underfeeding may result in stress for the farmed fish due to competition for feed. If the fish does not get enough food, growth is reduced and feed conversion ratio increased (FCR—kg. feed used/kg. biomass gained).

FIG. 3 shows the relationship between ration size (Ration) and feed conversion ratio (FCR—black curve). At very small rations, growth (Growth % per day—grey curve) is negative (metabolic costs are higher than net energy intake and the fish loses weight). At larger rations, growth increases and feed conversion efficiency improves, but as rations exceed what the fish can utilize, growth stagnates and excessive feed leads to poorer feed conversion. In general, excessive feed leads to feed spillage, i.e. pellets sinking past satiated fish and through the cage bottom) rather than the fish eating more than it can utilize.

In the outgrowth phase for farmed Atlantic salmon large numbers of fish are aggregated in sea cages with relative small volumes. The basic requirement for keeping the fish alive in the sea cages is water with acceptable temperature and oxygen content. One challenge for the fish farming industry is that water contains very small amounts of oxygen. In one litre of air-saturated sea water at 15° C. there is ˜8 mg of dissolved oxygen. The dominating source of oxygen for salmon in cages is the continuous replacement of water by currents through the cage. Atlantic salmon uses about 4 mg oxygen per kg of body mass per minute (depending on fish size, feeding state and temperature). Ideally, salmon should be offered oxygen saturated water, but even to maintain oxygen levels in the water flowing out of the cage above 75%, each 4 kg salmon requires over 10 tons of newly oxygenated water each day. Variability in oxygen concentration in the cage reflects variability in both consumption and supply. The lower the oxygen concentration, the less motivated the fish will be to feed and the less they will eat. In a recent experiment we found the temperature-dependent critical saturation oxygen saturation thresholds for fed, normally active post-smolt salmon, under which they were unable to sustain their oxygen consumption rate (FIG. 4 below). This critical concentration is much higher at high than at lower temperatures, being about 27% at 6° C., 40% at 12° C. and 60% at 18° C. Appetite and growth will be negatively affected also by less severe hypoxia than these critical values, and even at saturation levels of 70 and 80% reduced feeding and growth has been observed. In the densely populated sea cages the fish also influence their own water quality, especially the saturation of oxygen. Increased feeding, digestion and growth inevitably cause higher oxygen consumption, as seen in FIG. 5 below, and further reduction of the oxygen saturation. This means that an oxygen saturation that supports appetite, feeding and growth may not be sustained if the fish are fed till satiation. Forecasting the effect of feeding on oxygen saturation is therefore useful when deciding whether and how much to feed. What should also be taken into consideration is the anticipated short term (hours) development in DO (Dissolved Oxygen). DO in sea cages typically displays a cyclic pattern, either driven by 6 hour tide periods or day/night differences in photosynthetic activity during algal blooms (FIG. 5). This means that how much fish should be fed at a given quite low DO level depends on whether the level it is a temporary low or high or whether conditions are stable

As oxygen delivery rate (water flow) to the cage varies strongly between cages and in time, estimating the oxygen consumption rate of salmon in a sea cage from readings of saturation in the cages is very difficult due to the massive uncertainties regarding the water replacement rate and distribution of the fish. However, assuming that the inflowing water to the cages is close to air saturation in oxygen content, calculating the effect on oxygen saturation of a given relative change in oxygen consumption is straight forward. If feeding a given ration is assumed to increase oxygen consumption rate with X %, the effect on oxygen saturation is:

$${DO}_{after} = {DO}_{before} - \frac{X}{100} \times ( 100 \% - {DO}_{before} ) \qquad ( a )$$

For instance, if DO_{before} is 90%, a 50% increase in oxygen consumption will give a DO_{after} of 85%. If DO_{before} is 60%, a 30% increase in oxygen consumption will give a DO_{after} of 48%. Therefore, combinations of rather low DO and high temperature (demanding high DO values) suggest restricted feeding, not only because appetite may be reduced, but also because feeding the fish till satiation may lead to problematic load on the water quality. Typically, total metabolism of fed fish during day is about 30% higher than in the morning before first feeding. The further increase in oxygen consumption rate after later meals is much more modest (FIG. 7). Also, digestion and growth metabolism has less diel variability in large fish and at lower temperatures.

Also, the immediate response of the fish to the offered feed reflects how motivated they are to feed. In experiments, we have observed that the intensity of the motivation to feed is closely related to the immediate increase in oxygen consumption (νo₂) when feed is offered (FIG. 5). We have found that feed uptake may be quite normal even though the fish displays less motivation and feeding intensity, but the capacity of the fish to eat feed offered at a very high rate before it sinks through or is washed out of the cage is probably strongly affected. Feeding activity below the absolute surface is not easily observable, but DO measurements are non-intrusive proxies for intensity of feeding behaviour. The lack (or decay during feeding sessions) of feeding intensity, inferred from DO readings, should not necessarily lead to stopping feeding, but reducing the feeding rate. High current velocities reduces the capacity of the fish to eat the feed faster than it is lost from the cage, so the need for modulating the feeding intensity based on estimated feeding activity of the fish will depend on current velocities.

In addition to FCR, the rate with which the fish stocks grow is very important for the fish farmers. Water temperature and feed intake are the most important factors for the growth rate, but also factors like genetic strain, fish size, diet, and health and water quality have large impact on the growth. Specific growth rate (SGR) is found from the formula:

$$S G R = \frac{ln {Weight}_{final} - ln {Weight}_{initial}}{{T}_{days}} \qquad ( b )$$

Table II shows an extract from Skretting's Specific Growth Rate (SGR) matrix, cf. Skretting AS, “Den norske fôrkatalogen 2009,” S. AS, Ed. Stavanger: Skretting A S, 2009. For Atlantic salmon at size 900 gram and temperature of 10° C., Table I gives a SGR of 1.00% day-1. The additional salmon mass produced for 10,000 salmon at a given farm in one day would then be:

For 900 g Atlantic salmon the FCR is 0.88 so the total amount of feed eaten by the 10,000 fish that day would then be:

TABLE II

| TEMPERATURE SIZE | 10° C. | 11° C. | 12° C. | 13° C. | 14° C. | 15° C. | FCR |
|---|---|---|---|---|---|---|---|
| 900 g | 1.00 | 1.08 | 1.14 | 1.20 | 1.24 | 1.26 | 0.88 |
| 1000 g | 0.95 | 1.03 | 1.09 | 1.14 | 1.18 | 1.20 | 0.88 |
| 1100 g | 0.91 | 0.98 | 1.04 | 1.09 | 1.12 | 1.14 | 0.89 |

Fish feeding behaviour and the satiation time are both of importance to fish farmers of Atlantic salmon whose goal are to maximize growth and minimize FCR. To reach these goals farmers must adapt the feeding regimes such that the fish are fed to satiation without wasting feed. There are three main considerations for feeding regimes which should be adjusted to maximize consumption, growth and conversion efficiencies:
Feeding frequencies
Ration size
Feeding intensity

Appetite for salmon will vary between each individual, throughout the day and from day to day. The control mechanisms for satiety and food intake are shown to be complex with a high number of factors, and are not clearly defined. Environmental and physiological factors are considered to have mayor impact on the control of feeding behaviour. Several factors cause different appetite between fish in a breeding unit, such as:
Level of feed in stomach
Feed availability
Health status and stress level
Dominance relationships
Infections and sea lice
Hormonal conditions caused by inheritance or life stage

Natural variation in feed intake in a fish population from day to day is 20 to 30% when the fish are fed to satiation in every meal or every day. The variations in appetite are shown impossible to calculate in advance with sufficient accuracy. It is therefore necessary to use sensors or other surveillance equipments to better be able to detect when the fish are fed to satisfaction. Several trials on Channel Catfish in the period from 1968 to 1979 have shown that fish fed twice a day used feed more efficiently than did fish receiving one feeding daily. The effect of feeding more than two meals a day gave both positive and negative impact on growth and FCR, and results indicates little or no improvement at all. Experiments using self feeders (the fish are trained to control the feeding themselves) have shown that salmonids prefer to eat about 60% of daily ration in the morning and the rest of the afternoon/dawn. Based on these findings, it is common practice in Atlantic salmon fish farms to feed the fish two meals a day. But there are also farmers which prefer to feed the fish continuously or in smaller portions throughout the day (sequence feeding). It is important though to be consistent with the feeding regimes, as the salmon adapts to the feeding rhythm, and changes in regimes will lead to lowered farm performance before the fish are adapted to the new regime.

It is also known that feeding regime could have effects on the potential damage by infections.

An effective automated feeding system must be able to adapt both feed rate and feed amount to fish appetite and production planning, and to deliver the meals according to fish appetite to give optimal fish growth and best possible FCR. Fuzzy logic is very well suited for the controlling system with several inputs based on human (linguistic) knowledge and experience. The system layout of the new fuzzy logic control for fish feeding is shown in Figure. The system uses a fuzzy logic inference engine to control the feeding based on inputs from a simulation model (FFISiM), sensor output, other relevant input sources and a collection of predefined rules in the fuzzy logic rule base.

FFISiM (Fish Farming Industry Simulation Model) Seawater is a fish farm simulation model presented by one of the inventors of the present disclosure (cf. R. Melberg and R. Davidrajuh, “Modelling Atlantic salmon fish farming industry,” in IEEE International Conference on Industrial Technology, ICIT 2009, Melbourne, Australia, 2009, pp. 1370-1375), and later improved by both the authors of the above publication together with the second inventor of the present disclosure.

The above-mentioned model simulates daily feeding, growth and losses in the fish farming cage and supplies the inference system with daily prediction of feed requirements for the simulated sea cage. This approach ensures a flexible system where the simulation model could be used to compensate for the lack of sensors like the biomass estimators. The simulation model accumulates fish growth and losses, and would therefore keep track of the predicted amount of biomass in the sea cage. For sites with biomass estimators the figures in the model could be updated with the relative accurate estimates from the biomass estimator, and continue the simulation process, cf. Vikki Aquaculture Systems Ltd, “The Biomass Counter,” Kópavogur, Iceland: http://www.vaki.is/Products/BiomassCounter/, 2009. The number of fish in the model could also be updated as long as the fish farmers keep track of lost fish. The temperature matrix used in the initial simulation model is replaced with output from temperature sensors, which of course is more accurate for the given production site. The simulation model gives estimates for the daily required feed amount, but this would usually not be the same figure as the actual feed amount distributed in the sea cage the same day. The fuzzy logic inference engine control the feeding, and the simulation model is therefore updated with the actual daily feeding to be able to simulate most accurate daily growth. If the differences between the predicted feed amount and the actual amount of feed distributed is larger than natural variations in fish appetite it could be an early indication for unwanted situation in the fish farm. Fish loss registered from counting dead fish removed from the sea cage could be registered in the model. The built in model part for simulation of fish loss is extended with a new part for handling registration of dead fish, the initial fish loss model part simulates other loss such as escapes and loss to predators.

### A. Sensors and Input Parameters

For the system to be able to control the feeding it is important to get system input of parameters which could be used to determine when to feed and when to stop feeding. The possible system inputs have been divided into 3 categories; Environmental sensors, uneaten feed detection and Feeding preferences, and other inputs.

### 1) Environmental Sensors

Environmental conditions are shown to have a considerable impact on fish appetite. There are available sensors for continued registration of several environmental factors, cf. FASTFISH, “Welfaremeter—The Prototype,” in Norwegian fish farmer workshop II Bergen, Norway, 2009.

Environmental factors that have shown influence on feeding behaviour of fish:
Temperature sensor (° C.). Temperature is known to have major impact on the fish's energy requirement and appetite. All feeding regimes and growth models include temperature as an important factor. The oxygen content in the water is also dependent on the water's temperature; cold water holds more oxygen than warm water at the same dissolved oxygen level.
Current sensor. The sensor registers the current speed (for example caused by tidal water movement) and can be used to prevent unnecessary feed waste caused by tidal currents. If the current is high, more feed will follow the current out of the sea cage before the fish have time to eat it.
Oxygen (% and mg/l). There are several different types of Optical Oxygen Sensors that can stop the feeding at low oxygen levels in the water
Salinity (ppt). The best growth performance for Atlantic salmon is known to be in the interval 22-28 psu.
Turbidity (FTU). High density of particles in the water can in itself be harmful for fish gills. Moreover, turbidity is a proxy for plankton algae, that can represent a problem both due to toxic blooms and as a high algae biomass can consume much oxygen during dark nights, thus contributing to environmental hypoxia in the cage.
Fluorescence (μg/l). Fluorescence is a better proxy for algae biomass than turbidity.
Nitrogenous compounds (NH3, NO3, NO4+, etc). In flow through systems, as sea cages, these compounds rarely represent problem, while in recirculating systems, contamination of the water with these compounds can impair fish appetite and feeding capacity.
Light conditions (intensity, photoperiod, spectrum, shadowing). Light conditions modulate fish behaviour, and are a potential parameter candidate for the feeding system.

### 2) Uneaten Feed Detection

Overfeeding or feeding at a too high rate will lead to feed sinking uneaten through the sea cage. There exist several more or less successful systems for detection of uneaten feed pellets falling through a sea cage.
Underwater camera. Images from the underwater camera could be processed with image analysis systems to detect the amount of uneaten pallets sinking through the sea cage. It is also common to use workers to monitor the screens to look for uneaten pallets. Both the automatic and manual results from underwater camera could be used as an input to the automated control system proposed. The person monitoring the screens must than input the level of pallets sinking through the screen as for example; none, very few, few, some, more, and quite many etc. which could be used for fuzzy inference together with the other available system inputs.
Doppler systems. This prior art pellet sensor is installed below the fish' main eating area in the cages and uses Doppler technology to detect uneaten pellets.
Sonar systems. This prior art sensor analyses the echo energy from a 360° horizontal acoustic beam to detect food pellets sinking through the cage.
IR Pellet detection. This prior art sensor is placed 5-8 meters below the feeding area, and uses a funnel to lead the pellets through an Infra-Red beam, which detects and counts the pellets.

### 3) Feeding Preferences and Others Inputs

In addition to environmental factors there are several other factors that affect the feeding behaviour of the fish or preferences by the farmer:
Daily feeding rhythms
Fish size (average)
Pellets size
Fish amount/biomass (fish count)
Time of day.
Time since last feeding.
Result parameters from last feeding.
Fed type parameters (DE).
Parameter for time to market preferences.
Seasonal variations
Stocking density
Genetics
Social structure (size variability, dominance hierarchy)
Human disturbance (weighing, cleaning, treatments, transferring, etc.).
Historical exposure. (For example meal feeding vs. sequence feeding, most important to be consistent; fish adapt to feeding pattern)
Health status

### Fuzzy Logic Inference and Rule Base

There are several approaches for setting up the rule base in fuzzy logic systems. In Atlantic salmon fish farming much of the feeding control is presently based on skilled vision by the fish feeders. Fuzzy logic is very well suited for controlling the system with several inputs based on human (linguistic) knowledge and experience. This information could be used to create (fuzzy) rules to be used by the automated feeding system. Another approach is to train the system while the feeding is controlled by expert fish farmers. In both cases it is important that the input sensors to the system reflect the factors that are emphasized by the experts for their feeding decisions.

It is also possible to extract rules from historical feeding data, but this would require that the feeding statistics is connected to feeding results, environmental sensor registration during feeding and other relevant parameters during feeding.

Another important consideration for creating rule base in control system for fish feeding is the competition between companies in the industry; a competing company would not reveal their feeding control secrets or statistics. The rule base must then be set up according to whatever information that is available from companies.

The rule base must also reflect the local variations from fish farming site to site. At one site the current speed of 20 m/s could be extreme high, but for other sites this could be a quite common current speed. The rules must than be adapted to the conditions at the condition on the site where the feeding control is implemented.

### APPLICATION EXAMPLE

This application example or embodiment shows a possible usage and implementation of a system according to present invention. FIG. 8 shows the system layout and the different sensors used. A biomass estimator is used to update the average fish weight in the model, and differences between modelled and actual growth are stored in the feeding statistic database for future analysis. A Doppler pellet sensor with built in camera is not used as an input for the fuzzy logic control system in this setting, but is rather included as a possible surveillance opportunity for feeding efficiency and possible feed wastage. Using pellet wastage as a control mechanism for feeding purpose have been implemented in several systems, and would also be a valuable input parameter in the fuzzy logic controlled automated feeding system. But the feeding control 4 example introduces a new approach to the feeding control based on oxygen consumption. The example farm feeds two meals a day, which is a very common way of feeding in salmon farms. Meal one is feed in the morning, and in this meal 60% of the predicted feed requirement from the FFISiM Seawater model is fed at a constant rate. The remaining 40% is more than the daily change in the fish appetite, so it is unlikely that the feeding will be stopped before 60% of the calculated feed amount is fed, unless the current is very high. Therefore it is the evening meal which would be regulated by all the three inputs for the fuzzy control system: Predicted hunger, oxygen consumption change and water current.

In the system shown in FIG. 8, a feed blower is identified by reference numeral 1, a feed silo by reference numeral 2, a feed distributor by reference numeral 3, an automated feeding system using a FFISiM Seawater Fuzzy logic controller by reference numeral 4, a biomass estimator by reference numeral 5, a current sensor by reference numeral 6, a temperature sensor by reference numeral 7, a Doppler pellet sensor by reference numeral 8, an oxygen sensor by reference numeral 9, a sea cage by reference numeral 10 and a rotor spreader by reference numeral 11, respectively. As indicated by arrows in the figure, the Fuzzy logic controller 4 receives input from any of the sensors 5-9, and output from the Fuzzy logic controller 4 serves as input for a feed providing system comprising the feed blower 1, the feed silo 2, the feed distributor 3 and the rotor spreader 11 in order to continuously control the amount of food spread by the rotor spreader 11 into the sea cage 10.

### A. Predicted Hunger

The predicted hunger input parameter is continuously calculated in the Fuzzification part of the system based on the difference between predicted feed requirements from the simulation model and actual amount of feed fed the given day. The scale goes from −100 to 100. Before the feeding starts the parameter value is 100. When the value is zero, the amount fed is the same as the predicted feed requirement, and parameter value of −100 means that the fish have been fed twice the predicted daily feed requirement. For the morning meal the parameter would go from 100 to 40, and based on the observations of daily variations in appetite for farmed salmons, the value would not go below around −30 during normal operation.

$${f}_{hunger} = 100 - \frac{{F}_{fed}}{{F}_{predicted}} \times 100 \qquad ( c )$$

FIG. 9 shows hunger membership functions.

B. Oxygen Consumption (dDO)

The relative change (decrease) in DO is used as a measure of how motivated the fish are to feed as it is a linear proxy for the fish's extra oxygen consumption while chasing feed (cf. FIG. 5 and the related description above). The DO level is continuously monitored, and the initial DO level is recorded prior to feeding. During the meal the parameter for oxygen consumption is calculated by using the function:

$${f}_{\partial DO} = \frac{{DO}_{init} - {DO}_{current}}{100 \% - {DO}_{init}} \times 100 \qquad ( d )$$

FIG. 10 shows dDO (changes in Dissolved Oxygen) membership functions.

### C. Oxygen Conditions

While reduced DO during feeding is an indication that the fish are eagerly searching for and chasing the feed, low DO in itself is very negative. Negative effects of already low DO may be accentuated by feeding. The increased metabolism due to feeding, digestion and growth increases both the consumption of oxygen, thereby reducing DO, and the need for high DO levels. The combination of quite poor DO levels and high feeding rates should therefore be avoided. In addition, we add a precautionary function that includes observed DO variability and the potential for the environment to deteriorate further due weakening tides etc. We assume that past temporal variability to some extent predicts future variability. Here, we assume that DO levels comparable to the average of the 25% lowest DO values during the last 24 h (DO_{25% low}) is likely to occur again. Therefore we calculate a conservative DO, DO_{safe}, which incorporates this:

$${DO}_{safe} = \frac{( DO + {DO}_{25 \% low} )}{2} \qquad ( e )$$

The reduced capacity to feed and grow at reduced DO together with the resulting effect of feeding on DO is included via the function,

$${f}_{OC} = \frac{{DO}_{safe} \times ( 12 - 0.33 \times T )}{100} \times 100 \qquad ( f )$$

FIG. 11 shows an oxygen condition membership function.

### D. Water Current

There are several current based factors in relation to fish feeding in sea cages environment which should be considered when feeding. First, the current make it necessary for the salmon to swim towards the current in order to hold the position in the sea cages. In the wild salmon do the same when holding the position in rivers during spawning season. Low current would not affect the feeding behaviour, but in strong current the fish would have some more trouble to feed at the same time as holding position inside the cage. Second, the current influence the feed distribution in the sea cage during feeding. Low current could have positive affect on the feed distribution and give a higher FCR, but high current would give more feed waste as the current brings feed pellets out of the sea cage before the fish have the time to eat it. At last, the current ensures circulation of water in the sea cages, such as new oxygen saturated seawater flow through the nets. This last effect would be counted for in the previous memberships functions, so only the effect on feed distribution and fish movement would be considered when setting up this membership function.

FIG. 12 shows current membership functions.

### E. Control Output

The control output from the fuzzy logic inference engine is used to set the feeding intensity for the automated feeders. The membership function for the feeding intensity, shown in FIG. 15, uses triangular-shaped built-in membership function. This membership function could be considered as a special case of the trapezoidal membership functions explained earlier, and used for the input membership functions, where b=c.

FIG. 13 shows a feeding intensity membership function.

### F. Rule Base

The rule base maps the input membership functions to the output membership function using a set of if-then rules. There are several approaches for setting up such a set of rules, and in this case a set of rules are generated based on expert knowledge (farmers' experience) and research results. The presented rules make a good starting point for a future implementation of a full scale prototype, but a set for use in production would require further research and location specific adaption to produce optimal feeding control fuzzy rule set for a given fish farming location.

System training is also an effective way of generating a rule set for the feeding control. When setting the system in training mode, the actual feeding control are done by expert farmers, and the system records the sensor and model data together with the feeding information. In this way the system is trained to control the feeding by the expert farmers, and the feeding knowledge could be utilized in a more standard application. Costly surveillance equipment used in the training period, would than be paid of as long as the system operates the feeding in a way that gives optimal growth and feed utilization.

### Current

The values from the current sensor are used to stop feeding when the current is very high (VH) and to reduce the feeding intensity when the current is high or medium high according to the results as presented in M. O. Alver, et. al “Dynamic modelling of pellet distribution in Atlantic salmon (Salmo salar L.) cages,” Aquacultural Engineering, vol. 31, pp. 51-72, 2004, and in relation to the other parameters.

### 4) Oxygen Condition

The values from the oxygen sensor are used to stop the feeding when the oxygen level becomes very low or low. When the oxygen level is medium, the feeding intensity is reduced, and also for high levels the system will pay more attention to other negative factors.

5) Oxygen Consumption (dDO) and Predicted Hunger

The oxygen consumption and predicted hunger inputs are used together to control the feeding according to the fish appetite. The values for dDO are used to adjust the feeding rate, and eventually stop the feeding. If the predicted hunger is high or very high, low oxygen consumption will result in reduction of the feeding rate. But if the predicted hunger is medium low, the same low level of oxygen consumption will result of termination of the feeding.

FIG. 14 shows a control surface for feeding intensity for different combination of oxygen consumption and predicted hunger. The figure displays 3 of 5 dimensions of the total control surface.

As mentioned above, fish feed accounts for approximately 50% of the total production cost in Atlantic salmon farms. Underfeeding will lead to reduced growth and feed conversion ratio (FCR), while overfeeding will result in feed wastage and negative environmental effects. Both under- and overfeeding will then result in reduced profitability and less sustainable production. It is therefore important to be able to feed correct amount of feed, served at the right time, to ensure optimal growth and resource usage.

This disclosure presents a new automated fish feeding system which uses a simulation model, sensor inputs, and fuzzy logic for feeding control. The combination of a built in simulation model and sensor based controlling in the feeding system gives a robust and flexible system. The simulation model predicts the daily feed requirement, and also accumulates the simulated growth and fish loss, which could be compared to actual growth for farm performance analysis. The figures in the model could be updated by registered values from farm sensor or biomass estimators. If a sensor used as an input to the feeding control breaks down, the values from the model could be used while the sensor is being fixed. If the system detects large mismatch between the predicted feed usage and the actual feed amount, this could be an early indication of an unwanted situation such as fish disease or water pollution. The built in model could also be used to predict feed requirements, future stocking density etc. to aid the resource planning processes and production planning. An automated feeding system will also reduce the requirements for human resources for feeding purposes, and human labor could be focused on remote control function and maintenance.

Fuzzy logic systems are, as also mentioned in the introduction, well suited for using human expert knowledge (linguistic) and experiences, and the proposed system could be used to implement the expert feeding knowledge in different companies. This could either be done by setting up the rule base by using the expert knowledge and feeding statistics, or to run the system in training mode while the actual feeding is done by experts. For this to be successive, it is necessary that the sensor inputs available to the system are relevant for decision making for the feeding purpose.

The application example provides a new strategy for feeding control in Atlantic salmon aquaculture, where changes in measured dissolved oxygen is used as a proxy for fish appetite. Experiments have shown lowered levels of dissolved oxygen during feeding, and especially for hungry fish chasing the feed. Additional experiments are needed in order to set up an optimal rule base for the sensor usage in the application example, since existing theory and experiments already done show promising results. It is also possible that the system layout must include an oxygen sensor outside the sea cages to be able to better register the additional oxygen consumption during feeding. Used together with water current and temperature sensor, this will give more precise calculation of changes in oxygen consumption.

With the new application as proposed herein, one would (in addition to conventional application), continuously look at the oxygen consumption, and use the increased consumption during feeding as an indication of hunger. As the hunger gradually decreases, a less amount of fish will chase the feed, and the oxygen consumption correspondingly decreases. Changes in the amount of DO in sea cages can, based on this, be used to control feeding based on the hunger of the fish, and thus make an important contribution in the prevention of over or underfeeding.

The system according to the invention as described above is utilizing relative changes in oxygen saturation, however it is quite possible to have more accurate measurements where estimated biomass in the sea cage, current velocity and direction, measured oxygen in front of the sea cage in relation to current direction and temperature, are all accounted for. In an installation comprising for example eight sea cages, this will generally be obtainable with ten sensors, as the current direction generally has only two main directions based on tidal movements.

The oxygen sensors could be positioned at several depths, or it could be possible to have sensors that could be adjustable in height in order to adapt the measurements to the area at which the fish is feeding. This could be an option in hot periods when the fish would rather eat on deeper water where the temperature is cooler. This also supports a possible feeding on deep waters, which could, inter alia, be relevant for submersible sea cages.

Even if the application example or embodiment as described above and as shown in FIG. 8 utilizes a Fuzzy logic controller 4 for controlling the feed provision system, any type of controller being able to control the feeding based on changes of DO may be feasible.

Finally, it should also be noted that there is a 1:1 relationship between O₂ consumption and CO₂ production. Therefore it is in principal possible to use measurements of CO₂ as a proxy for oxygen concentration and consumption. However, most of the CO₂ produced by fish will be found as carbonate and bicarbonate, and this dynamic equilibrium is very pH sensitive. Operational assessment of oxygen consumption or concentration from CO₂ and pH measurements is probably not an option with existing technology.

1. A system for controlling feeding of farmed fish living within a restricted volume, comprising:
at least one sensor for direct or indirect measurement of changes in dissolved oxygen (DO) in a feeding area of the fish during feeding, and further comprising
a controller receiving input from said at least one sensor and providing output to an automated feed providing system for controlling the amount of food provided to the fish,
wherein an increased oxygen consumption and a correspondingly decreased amount of DO in said feeding area serves as an indication of fish hunger and an input parameter of the controlling system.

2. A system according to claim 1, wherein said at least one sensor is an oxygen sensor.

3. A system according to claim 1, wherein said at least one sensor is a sensor or a group of sensors for measuring or calculating CO₂ production from the fish in the restricted volume or sea cage.

4. A system according to claim 1, further comprising a biomass estimator, a current sensor, a temperature sensor, and a Doppler pellet sensor.

5. A system according to claim 1, the controller is a Fuzzy logic controller.

6. A system according to claim 1, wherein several sensors for measuring changes in DO are positioned at different depths, or that at least one sensor for measuring changes in DO is depth adjustable, within the restricted volume for measuring changes in DO at different feeding levels.

7. A system according to claim 1, wherein the automated feed providing system comprises a feed blower, a feed silo, a feed distributor and a rotor spreader.

8. A method for controlling feeding of farmed fish with a system as stated in claim 1, comprising the steps of:
indirectly or directly measure the changes in the amount of DO,
providing said measurements as input to the controller,
calculating the amount of feed in the controller based on said measurements, and
controlling the automated feed provision system based on outputs from the controller.

9. A method according to claim 8, further comprising using a FFISiM Seawater model for the controller, the controller being a Fuzzy logic controller.

10. A method according to claim 9, further comprising continuously calculating a predicted hunger input parameter in a Fuzzification part of the system based on the difference between predicted feed requirements from a simulation model and actual amount of feed fed the given day, using the function:
$${f}_{hunger} = 100 - \frac{{F}_{fed}}{{F}_{predicted}} \times 100$$

11. A method according to claim 9, further comprising continuously measuring a DO level, and recording an initial DO level prior to feeding.

12. A method according to claim 9, further comprising measuring the relative change in DO during a meal, using the function:
$${f}_{\partial DO} = \frac{{DO}_{init} - {DO}_{current}}{100 \% - {DO}_{init}} \times 100$$

13. A method according to claim 9, further comprising:
calculating a conservative DO, DO_{safe}, using the function:
$${DO}_{safe} = \frac{( DO + {DO}_{25 \% low} )}{2}$$
and, based on the above calculation, calculating a reduced capacity to feed and grow at reduced DO together with the resulting effect of feeding on DO via the function:
$${f}_{OC} = \frac{{DO}_{safe} \times ( 12 - 0.33 \times T )}{100} \times 100$$

14. A method according to claim 12, further comprising providing membership functions for the predicted hunger, f_{hunger}, and the relative change in DO, f_{dDO}, respectively.
